(19) United States
(12) Patent Application Publication
(10) Pub. No.: US 2007/0146423 A1
(43) Pub. Date: Jun. 28, 2007

(54) CARRIAGE DRIVING APPARATUS AND IMAGE FORMING APPARATUS

(75) Inventors: Shuichi Tamaki, Nagoya-shi, Aichi-ken (JP); Kenji Samoto, Nagoya-shi, Aichi-ken (JP); Kiyoshi Ueda, Nagoya-shi, Aichi-ken (JP); Toshio Sugiura, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/617,194

(22) Filed: Dec. 28, 2006

(30) Foreign Application Priority Data
Dec. 28, 2005 (JP) 2005-380149

(51) Int. Cl. B41J 23/00

(52) U.S. Cl. 347/37

(57) ABSTRACT

A carriage driving apparatus has a first and a second guide members that extend, being adjacent to each other, and a carriage mounted movably to and between the, parallel queuing, guide members. The carriage is movable reciprocally along a extending direction of the first guide member and has one side thereof in parallel to the extending direction and perpendicular to a queuing direction of the guide members. The apparatus includes an extending member provided at the first guide member, extending in the queuing direction and a regulating part provided on the one side of the carriage to extend in the queuing direction such that, when the carriage receives a stress in one direction perpendicular to both the extending direction and the queuing direction, the regulating part comes into contact with the extending member to regulate displacement of the carriage along the one direction.

### CROSS-REFERENCE OF RELATED APPLICATION

This non-provisional application claims priority under 35 U.S.C. §119(a) on Patent Application No. 2005-380149 in Japan on Dec. 28, 2005, the entire contents of which are hereby incorporated by reference.

### BACKGROUND

The present invention relates to a carriage driving apparatus equipped with a carriage for moving forward and backward along a scanning direction.

We, the applicants, have proposed a carriage driving apparatus (carriage scanner apparatus) which has a carriage arranged for moving forward and backward along a scanning direction thus to minimize the overall dimensions of an image forming apparatus.

The carriage (5) in the carriage driving apparatus is mounted between a pair of (first and second) guide members (22 and 23) which extend in one direction and arranged for moving forward and backward along the one direction of the guide members serving as a main scanning direction (See Japanese Patent Application Laid-Open No. 2005-246907 as shown in FIG. 7).

### SUMMARY

The foregoing carriage driving apparatus is however disadvantageous that its carriage mounted between the two guide members may be dislocated when receiving an upward stress. For compensation, the carriage has a projecting portion (referred to as a regulating part hereinafter) provided at one end thereof which faces the guide member, whereby when the carriage is displaced upwardly by an upward stress, its regulating part can come into contact with the lower surface at the carriage side edge of the guide member thus to inhibit the upward displacement of the carriage and permit no slipping off of the carriage.

It is hence essential due to the installation of the carriage in the apparatus to locate one of the two guide members equipped with the regulating part closer to the one side of the carriage or further from the other guide member.

However, if its side to be in contact with one of the two guide members located far from the other guide member, the carriage itself will be spaced from the guide members. It is hence necessary for ensuring the direct contact between the carriage and one of the two guide members to allow the regulating part of the carriage to extend more towards one of the guide member and simultaneously increase its thickness enough to provide a desired degree of the mechanical strength. When one of the guide members is provided integrally with its guiding surface for direct contact with the regulating part of the carriage, the regulating part of the carriage has to be correspondingly increased thus failing to deduce the overall cost of the carriage driving apparatus. Also, as there is hardly available a generous space for movement of the regulating part of the carriage, the mechanism for protecting the carriage from slipping off will be unfeasible.

It is hence an object for eliminating the above drawback to provide an improvement where when the carriage receives an upward stress, its regulating part can assuredly come into contact with the lower surface at the carriage side edge of one of the two guide members thus to inhibit any upward displacement of the carriage and permit no slipping off of the carriage.

It is another object to provide an improvement where the carriage is arranged with its side, which comes into contact with one of the two guide members, spaced further from the other guide member while remaining inhibited effectively from slipping off.

For achievement of the objects, there is provided a carriage driving apparatus according to an aspect having a first and a second guide members that extend, being adjacent to each other, and a carriage mounted movably to and between the, parallel queuing, first and second guide members, the carriage being movable reciprocally along a extending direction of the first guide member as being guided with the first and second guide members and having one side thereof extending in parallel to the extending direction and perpendicular to a queuing direction, comprising: an extending member provided at the first guide member, being formed in plate and extending in the queuing direction; and a regulating part provided on the one side of the carriage to extend in the queuing direction such that, when the carriage receives a stress in one direction perpendicular to both the extending direction and the queuing direction, the regulating part comes into contact with the extending member to regulate displacement of the carriage along the one direction.

In the carriage driving apparatus, the regulating part of the carriage is arranged on the first guide member side of the carriage to extend towards the first guide member so that when the carriage is displaced upwardly by an unwanted upward stress, the regulating part can come into contact with the lower surface at the carriage side edge of the first guide member thus to inhibit the upward displacement of the carriage. In addition, the extending member of a plate form is mounted on the first guide member to project from the carriage side towards the carriage.

The construction of the carriage driving apparatus allows the first guide member to extend its carriage side edge towards the carriage.

Accordingly, in case that the carriage side of the first guide member is spaced further by a distance from the second guide member, the width of its extending member can offset the distance thus permitting the lower surface at the carriage side edge of the first guide member to remain not separated from the carriage. As the result, the regulating part of the carriage can assuredly come into contact with the lower surface at the carriage side edge of the first guide member and effectively prevent the carriage from slipping off.

The above and further objects and features will more fully be apparent from the following detailed description with accompanying drawings.

### BRIEF DESCRIPTION OF THE SEVERAL VIEWS OF THE DRAWINGS

FIG. 1 is an external perspective view of a multi-function apparatus showing an embodiment;

FIG. 2 is a side cross sectional view of the multi-function apparatus of an embodiment;

FIG. 3 is a perspective view of a recorder unit in an embodiment (with a carriage mounted);

FIG. 4 is a perspective view of the recorder unit in an embodiment (with the carriage dismounted);

FIGS. 5A to 5C are upper, lower, and front views respectively of one end of a first guide member in an embodiment;

FIG. 6 is a right-side view of the recorder unit in an embodiment; and

FIG. 7 is a perspective view of a structure composed mainly of a main frame, the first guide member, and a second guide member in an embodiment.

### DETAILED DESCRIPTION

One embodiment of the present invention will be described referring to the relevant drawings.

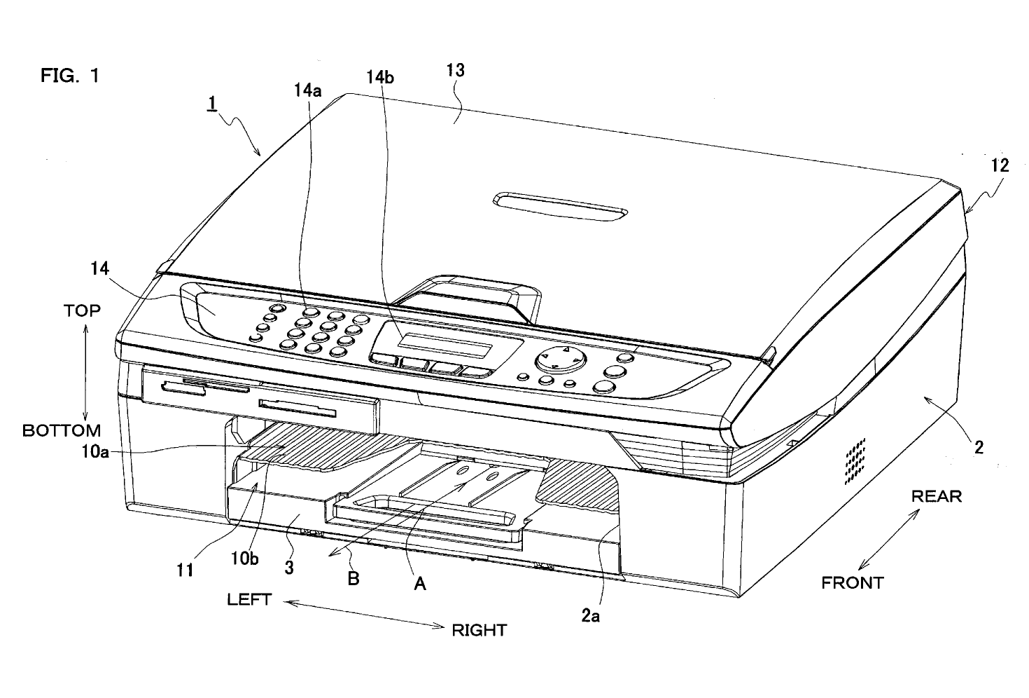

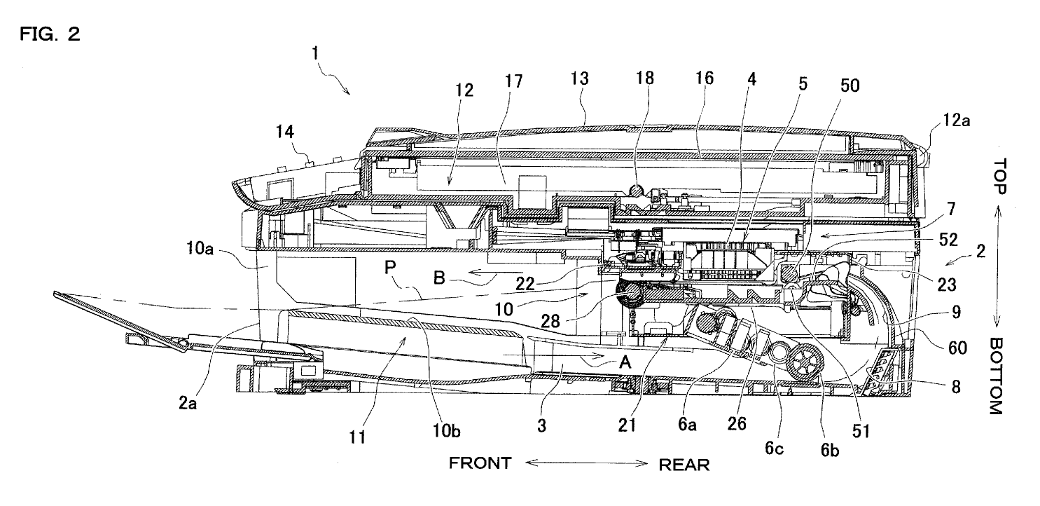

FIG. 1 is an external perspective view of a multi-function machine 1 as an image forming apparatus showing the embodiment of the present invention and FIG. 2 is a side cross sectional view of the same. It is noted throughout the following description that the multi-function machine 1 is based on its common service state (FIG. 1) with its upward and downward directions while the forward and backward direction extend from this (front) side where an operation panel 14, will be explained later, is located and the left/rightward direction are defined as viewed from this (front) side of the multi-function machine 1.

The multi-function machine 1 includes a printer function, a scanner function, a color copier function, and a facsimile function and has an image reader apparatus 12 mounted on the upper side of a synthetic resin housing 2 as shown in FIGS. 1 and 2.

The image reader apparatus 12 is arranged pivotable about a pivot shift, located at the left end as not shown, for opening and closing on the housing 2. An original cover 13 is mounted on the upper side of the image reader apparatus 12 and arranged pivotable about a pivot shaft 12a (See FIG. 2) located at the rear end for opening and closing on the image reader apparatus 12.

As shown in FIG. 2, the image reader apparatus 12 has an original placing glass plate 16 mounted to the upper side thereof on which an original to be scanned and read is placed with the original cover 13 opened. Provided beneath the glass plate 16 is a contact image sensor (CIS) 17 which is mounted for forward and backward movement along a guide shaft 18 arranged to extend in a direction (the left/rightward direction or main scanning direction) perpendicular to the sheet of paper in FIG. 2 in order to scan and read the original.

Moreover as shown in FIGS. 1 and 2, an operation panel 14 is provided at the front of the image reader apparatus 12 as including an array of control buttons 14a for entry of commands and a liquid crystal display (LCD) 14b for display of information.

A paper feeder 11 is mounted to the bottom of the housing 2 for feeding sheets of recording paper P as recording mediums. The paper feeder 11 has a feeder cassette 3 mounted to the housing 2 detachably in the front/rearward direction through its opening 2a at the front for storage of a stack of recording paper P. The feeder cassette 3 in the embodiment is arranged to hold a number of recording paper sheets P of, e.g., A4 size, letter size, legal size, or post card size of which the short side (width) extends along the direction (the main scanning direction or the left/rightward direction) perpendicular to the direction of feeding (the sub scanning direction or the front/rearward direction, as denoted by the arrow A).

A tilting separator plate 8 is disposed at the deepest end (the rear end) of the feeder cassette 3 for separating and feeding the recording paper, as shown in FIG. 2. The tilting separator plate 8 is arranged of an arcuate shape in the plan view which projects at the center along the widthwise direction (the left/rightward direction) of the recording paper P and sets back at both, left and right, ends along the widthwise direction. The tilting separator plate 8 has an elastic separator pad of a saw teeth shape provided at the center along the widthwise direction of the recording paper P for assisting the recording paper P to separate as coming into contact with the leading end of the recording paper P.

A feeder arm 6a is pivotably mounted to the paper feeder 11 for lifting up and down its distal end to dispatch the recording paper P from the feeder cassette 3. A feeder roller 6b is mounted to the distal end of the feeder arm 6a and driven by a force of rotation received from a feeding motor, not shown, via a gear transmission mechanism 6c disposed in the feeder arm 6a. A combination of the feeder roller 6b and the elastic separator pad of the tilting separator plate 8 can separate and dispatch each sheet of the recording paper P from the feeder cassette 3. The recording paper P separated and dispatched in the direction of feeding (denoted by the arrow A) is then transferred via a feeding passage 9 including a laterally extending U shaped path provided between a first transfer member 60 and a second transfer member 52 to a recorder unit 7 disposed above the feeder cassette 3. The recorder unit 7 is a carriage driving apparatus (carriage scanner apparatus) according to the present invention.

The recorder unit 7 includes a main frame 21 arranged of a top opened, leftwardly and rightwardly extending box-like shape, a pair of first and second guide members 22 and 23 supported at both, left and right, sides of the main frame 21, a carriage 5 mounted between the first guide member 22 and the second guide member 23, and an ink head 4 mounted to the carriage 5 for downwardly delivering a jet of ink.

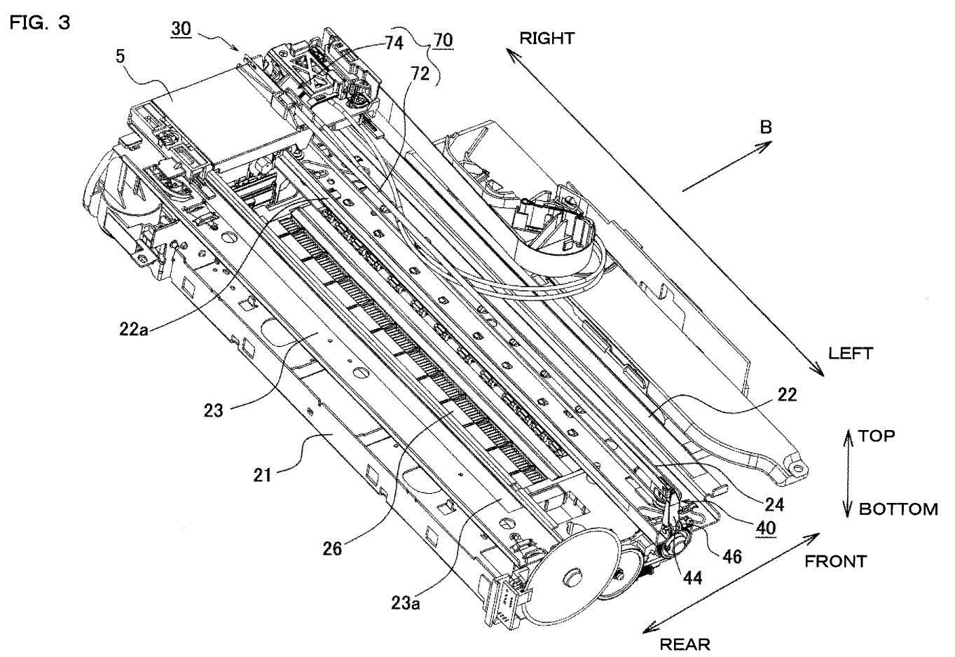

As shown in the perspective view of the recorder unit 7 of FIG. 3, the first and second guide members 22 and 23 are made of leftwardly and rightwardly extending plates and separated from each other along the direction of feeding of the recording paper P (the front/rearward direction). The first guide member 22 is located at the front side while the second guide member 23 is located at the rear side.

The first and second guide members 22 and 23 have sliding surfaces 22a and 23a thereof respectively arranged along the left/rightward direction (the main scanning direction) for guiding the carriage 5.

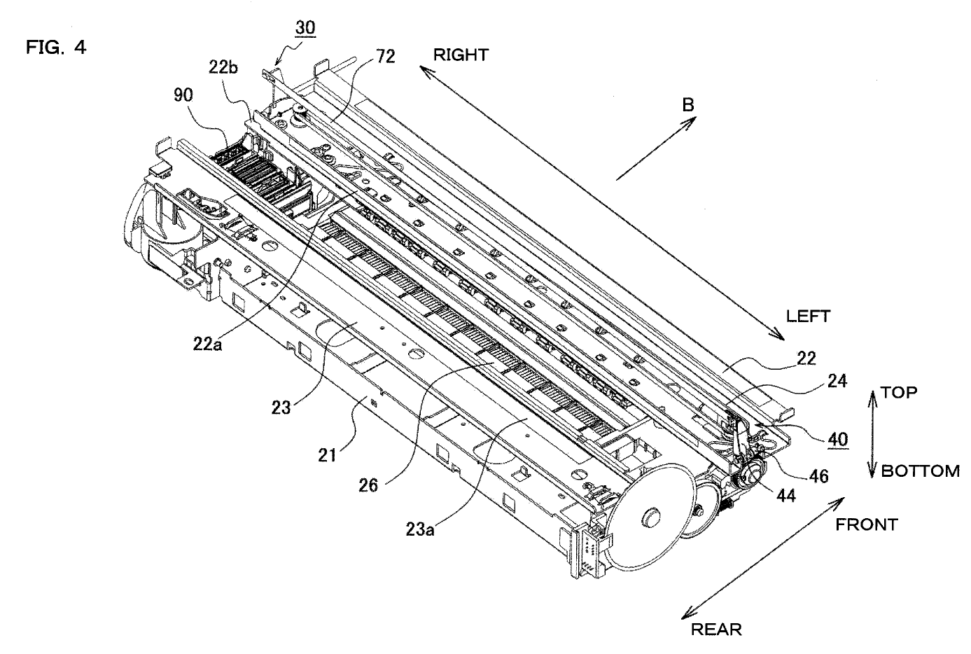

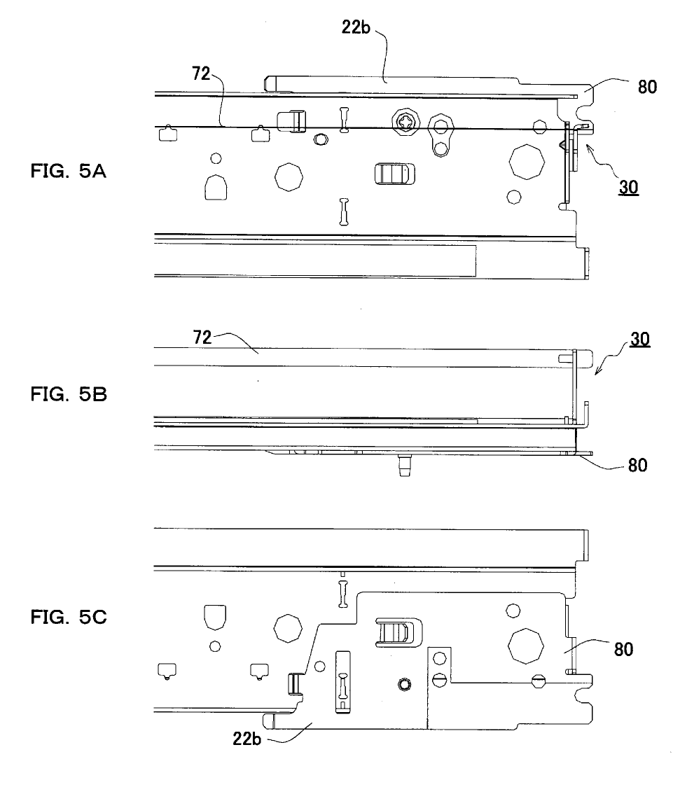

The first guide member 22 also has an extending member 22b provided on one side or carriage 5 side (where the sliding surface 22a extends) at one end (the right end in the embodiment) thereof along the left/rightward direction as shown in the perspective view of the recorder unit 7 with the carriage 5 dismounted of FIG. 4. More particularly, the extending member 22b is a dedicated portion of a plate member 80 as shown in FIG. 5 which illustrates an upper, a lower, and a front view of the one end of the first guide member 22. In the embodiment, the plate member 80 is fixedly mounted to the first guide member 22 so that its dedicated portion extends to the carriage 5. FIGS. 5(a), 5(b), and 5(c) are the upper view, the front view, and the lower view.

The carriage 5 is slidably supported by and between the first guide member 22 and the second guide member 23 (or between their rails) for forward and backward movement along the main scanning direction or the lengthwise direction the guide members 22 and 23, as best shown in FIG. 3. For the forward and backward movement along the main scanning direction, the carriage 5 is driven by a timing belt 24 provided above the first guide 22 along the main scanning direction and linked to a carriage (CR) motor not shown.

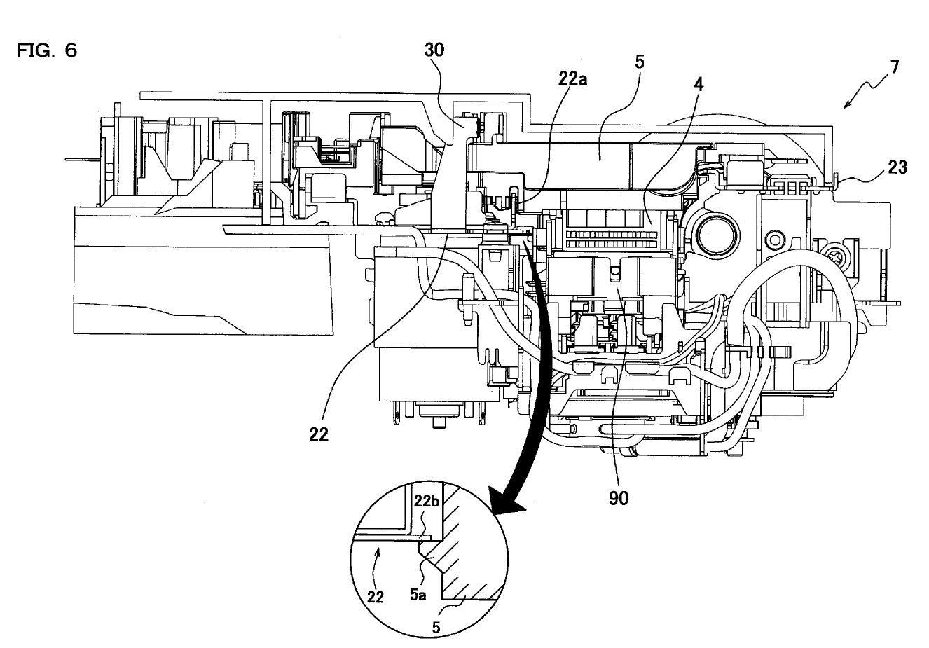

Also, the carriage 5 has a regulating part 5a provided at the first guide member 22 side thereof to extend towards the first guide member 52 as shown in the right side view of the recorder unit 7 of FIG. 6. When the carriage 5 is displaced upwardly by any upward stress, its regulating part 5a comes into contact with the lower side at the carriage 5 side of the first guide member 22 thus to inhibit the upward displacement of the carriage 5.

Also as shown in FIG. 4, a maintenance mechanism 90 is mounted at one end (the right end in the embodiment) along the left/rightward direction beneath the ink head 4 of the carriage 5 for conducting a maintenance action for the ink head 4 of the carriage 5. In this respect, the extending member 22b of the first guide member 22 is so located as to come into contact with the regulating part 5a of the carriage 5 at least above the maintenance mechanism 90 on the one end of the recorder unit 7 where the carriage 5 rests.

When the maintenance mechanism 90 supports directly the ink head 4 of the carriage 5 from below the carriage 5 which rests at the one end, it can conduct its maintenance action for the ink head 4 (for example, a capping action or a wiping action).

As the other region than the one end of the recorder unit 7 is arranged planer beneath the ink head 4 of the carriage 5 along the left/rightward direction as shown in FIGS. 3 and 4, a platen 26 is fixedly mounted to a main frame 21 between the two guide members 22 and 23 for supporting the recording paper P from beneath as facing the ink head 4.

As shown in FIG. 2, a driving roller 50 and a nip roller 51 arranged to face the driving roller 50 from beneath are provided as a pair of resist rollers at the upstream side of the platen 26 along a direction of discharging (denoted by the arrow B) for transferring the printing paper P to the upper side of the platen 26 (beneath the ink head 4). On the other hand, provided at the downstream side of the platen 26 along the direction of discharging (denoted by the arrow B) are a discharge roller 28 arranged to be driven for transferring the recording paper P from the recorder unit 7 to a discharge unit 10 and a spur roller (not shown) pressed against the discharge roller 28.

The discharge unit 10 for receiving from the recorder unit 7 the recording paper P with its recording side facing up where an image is recorded is located above the paper feeder 11 and arranged of which the opening 10a for discharging the printing paper P is equal to the opening 2a at the front of the housing 2. The printing paper P discharged from the discharge unit 10 in the direction of discharging (denoted by the arrow B) is then received by a receiving tray 10b of the discharge unit 10 located at the inner side of the opening 2a of the housing 2.

Furthermore, an ink storage not shown is provided at the right front of the housing 2 beneath the image reader apparatus 12. The ink storage contains four ink cartridges installed detachably for storage of four different colors, black (Bk), cyan (C), magenta (M), and yellow (Y), of ink for producing a full color image, which can be removed when the image recorder apparatus 12 is displaced upwardly for opening. The ink cartridges are communicated by four ink supply tubes to the ink head 4, thus allowing the colors of ink to be distributed from the ink cartridges via their respective ink supply tubes to the ink head 4.

As shown in FIG. 2, also mounted on the first guide member 22 in the recorder unit 7 are a first extension 30 provided at the one (right) end of the first guide member 22, a second extension 40 provided at the other (left) end of the first guide member 22, and a linear encoder 70 for detecting the location of the carriage 5.

As extending from both ends of the first guide member 22, the first and second extensions 30 and 40 intersect with the front/backward direction and the main scanning direction respectively and project in a direction away from the first guide member 22 (the upward direction in the embodiment).

A supporting member 44 of a resin material extending to a length is mounted on the second extension 40 for shifting between a common upwardly extending state and a tilting state for tilting towards the first extension 30 and remains urged to the common state by an urging means (a coil spring in the embodiment) 46.

The linear encoder 70 comprises an encoder strip 72 made of a belt of a resin material and a linear sensor 74 for reading a pattern of measurement (not shown) from the encoder strip 72.

The encoder strip 72 is extended between and supported by the distal end of the first extension 30 and the distal end of the second extension 40.

The linear sensor 74 is a sensor system of photo-interrupter type mounted on the carriage 5 and having a light emitter and a light receiver arranged to sandwich the encoder strip 72 above the upper side of the carriage 5. As the carriage 5 travels forward and backward along the main scanning direction, its linear sensor 74 moves and reads a pattern of measurement from the encoder strip 72 thus to determine the location of the carriage 5 in relation to the encoder strip 72 in the stroke along the main scanning direction.

As described, the recorder unit 7 in the multi-function machine 1 permits the extending portion (extending member) 22b of the first guide member 22 beneath the carriage 5 to extend towards the carriage 5 at the one end of the machine 1.

Accordingly, when the carriage 5 side of the first guide member 22 is separated from the second guide member 23, the extending member 22b of the first guide member 22 holds the carriage 5 not biased from the first guide member 22. This allows the first guide member 22 to definitely come at the lower side into contact with the regulating part 5a of the carriage 5, hence effectively preventing the carriage 5 from slipping off.

The extending member 22b of the first guide member 22 in the embodiment is located at one end along the left/rightward direction or the lengthwise direction of the first guide member 22 as stays above the maintenance mechanism 90.

Accordingly, upon receiving an upward stress while staying above the maintenance mechanism 90, the carriage 5 comes at its regulating part 5a into contact with the extending member 22b of the first guide member 22. More particularly, even when the carriage 5 is displaced upwardly by an upward stress created during the maintenance action of the maintenance mechanism 90 for the ink head 4, its upward displacement can be inhibited by the action of the regulating part 22b. As the result, the carriage 5 will effectively be protected from slipping off.

The extending member 22b of the first guide member 22 is implemented by a dedicated portion of the plate member 80 provided separately of the first guide member 22 and fixedly joined to the first guide member 22 for inhibiting the slipping off of the carriage 5. Since the first guide member 22 is made simply by sheet metal working of a plate material with no consideration of the slipping off of the carriage 5, its cost can be minimized.

Also, as the extending member 22b is shaped from a single plate material 80 separately of the first guide member 22, its size can be smaller than that of the first guide member 22. It is commonly known that the greater the size, the higher the cost of the plate material will increase. Even when the plate material 80 has to be additionally used, the overall cost will be decreased as compared with the extending member 22b shaped integrally with the first guide member 22 of a greater size.

While the extending member 22b is shaped from the plate material 80, the first guide member 22 needs not to be integrated with the extending member 22b of a shape and can thus be increased in the freedom of designing. In addition, since the extending member 22b is separately made with a less number of processing limitations than that of the first guide member 22 integrated with the extending member 22b, its shape can be increased in the freedom.

For example, although the carriage driving apparatus of the embodiment is applied to the recorder unit 7 of the multi-function machine 1, it may be used with equal success in any other system than the recorder unit 7 of the multi-function machine 1 where the carriage is employed for scanning actions.

In the embodiment, the extending member 22b of the first guide member 22 is provided at one end of the machine along the left/rightward direction of the first guide member 22. However, the extending member 22b is not limited to the one end but may be disposed at any region of the machine 1.

For example, the extending member 22b may be provided at the carriage 5 side throughout the length of the first guide member 22. This will ensure the direct engagement between the first guide member 22 and the regulating part 5a of the carriage 5 regardless of the location along the main scanning direction of the carriage 5 when being displaced upwardly by the upward stress. More specifically, whenever the carriage 5 is located along the main scanning direction, its displacement due to any undesired lifting force can successfully be inhibited and its slipping off will effectively be avoided.

For providing the extending member 22b at the carriage 5 side throughout the length of the first guide member 22, the following arrangement of the first guide member 22 may be preferably employed.

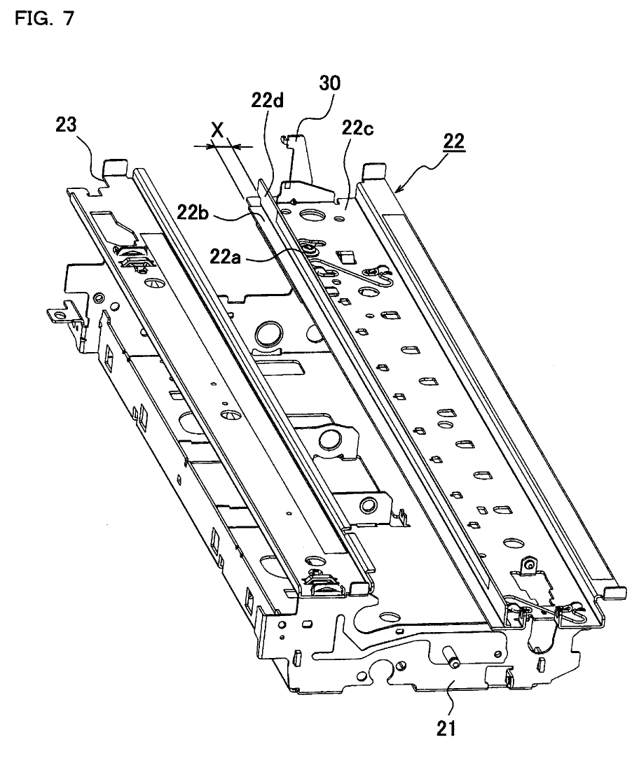

As shown in the perspective view of FIG. 7 where the main frame 21, the first guide member 22, and the second guide member 23 are combined to an assembly in the recorder unit 7, the first guide member 22 has a guide member (rail member) 22d provided on a main plate 22c thereof for guiding the carriage 5 along a sliding surface 22a which extends in the main scanning direction. More particularly, the rail member 22d is spaced by a distance x from the edge of the carriage 5 side of the main plate 22c as viewed along the plane of the first guide member 22 perpendicular to the main scanning direction, whereby the edge portion (at the width x) of the main plate 22c between the carriage 5 side edge and the rail member 22d of the first guide member 22 can act as the extending member 22b.

In common, since the guide member has to be highly accurate at the sliding surface for securely guiding the carriage 5, it will be constructed by expensive material.

However, the guide member (rail member) 22d with the sliding surface 22a of the first guide member 22 is provided separately of the main plate 22c which acts locally as the extending member 22b. While the rail member 22d of the first guide member 22 is made of an expensive material for ensuring the sliding surface 22a at a higher accuracy, the main plate 22c may be made of a less expensive material which needs no higher accuracy. Accordingly, the first guide member 22 remains low in the production cost while not sacrificing its function at higher accuracy.

In this arrangement, the extension of the first guide member 22 may be situated at any location on the carriage 5 side along the lengthwise direction of the first guide member 22.

In case that the maintenance mechanism is applicable to the carriage driving apparatus for conducting a maintenance action (for example, a capping action or a wiping action) on the ink head of the carriage, its service area in the carriage driving apparatus only may be covered with the extension of the guide member.

The carriage driving apparatus is arranged in which as the carriage has been moved and located at the service area along the main scanning direction, the maintenance mechanism is operated to come into direct engagement with the ink head of the carriage from below and start the maintenance action. The extension at the carriage side of the first guide member is therefore so located as to come into contact with the regulating part of the carriage in the service area.

This arrangement allows the carriage, when being displaced upwardly by an upward stress, to come at its regulating part to direct contact with the extension of the first guide member at least throughout the service area of the maintenance mechanism. In other words, when the carriage is displaced upwardly by an upward stress created during the maintenance action of the maintenance mechanism for the ink head, its upward displacement can be inhibited by the action of the regulating part. As the result, the carriage will effectively be protected from slipping off.

The extending portion (extending member) of the first guide member may be provided at the carriage side preferably throughout the length of the first guide member.

In the carriage driving apparatus, the extending portion (extending member) of the first guide member is provided at the carriage side throughout the length of the first guide member.

When the carriage is displaced upwardly by any upward stress, its regulating part comes into contact with the extension of the first guide member regardless of its location along the main scanning direction. More particularly, the upward displacement of the carriage can be inhibited throughout the length along the main scanning direction. As the result, the carriage will effectively be protected from slipping off.

Alternatively, the extension of the first guide member may be provided throughout the carriage side.

The rail member of the first guide member has a sliding surface provided on the main plate thereof along the main scanning direction for guiding the carriage. The rail member of the first guide member is spaced by a distance from the edge of the carriage side of the main plate as viewed along the plane of the first guide member perpendicular to the main scanning direction, whereby the edge portion of the main plate between the carriage side edge and the rail member of the first guide member can act as the extension.

In common, since the guide member has to be highly accurate at the sliding surface for securely guiding the carriage, it will be constructed by expensive material.

However, the rail member with the sliding surface of the first guide member is provided separately of the main plate which acts locally as the extension. While the rail member of the first guide member is made of an expensive material for ensuring the sliding surface at a higher accuracy, the main plate may be made of a less expensive material which needs no higher accuracy. Accordingly, the first guide member remains low in the production cost while not sacrificing its function at higher accuracy.

The first guide member in the carriage driving apparatus may be modified to an arrangement in the carriage driving apparatus defined in claim 5.

In the carriage driving apparatus, the sliding surface of the first guide member is provided on the extension of the main plate along the main scanning direction for guiding the carriage. The extension is fixedly mounted in the form of a plate to the lower side at the edge of the main plate in such a relationship that at least one part of the extension projects towards the carriage.

In particular, the extension of a plate form is made separately of the first guide member in the arrangement and fixedly joined to the first guide member, thus preventing the carriage from being slipped off.

Since the first guide member is made of a plate material with no consideration of inhibiting the carriage from being slipped off, it can be minimized in the cost of the material.

Although the extension is made of a plate material separately of the first guide member, its size is far smaller than that of the first guide member. In general, the greater the size the higher the cost of a plate material will increase. Even when the extension is made of an extra plate material, its cost is less than that of the extension shaped integral with the first guide member and can remain favorably low.

It is also unnecessary to modify the first guide member for shaping the extension, because the extension is separately made of a plate material. Accordingly, the shape of the first guide member can be increased in the freedom. Moreover, since the extension is less limited to the shape than when the extension is made integral with a material of the first guide member and can be increased in the freedom of design.

Also, an image forming apparatus may be implemented using the carriage driving apparatus of the embodiment as arranged in which an ink head for delivering a jet of ink is mounted on the carriage and its printing action on a recording medium can thus be carried out as the carriage travels along the main scanning direction.

Accordingly, the image forming apparatus will successfully provide the same functions and advantages as of the carriage driving apparatus.

As this description may be embodied in several forms without departing from the spirit of essential characteristics thereof, the present embodiments are therefore illustrative and not restrictive, since the scope is defined by the appended claims rather than by description preceding them, and all changes that fall within metes and bounds of the claims, or equivalent of such metes and bounds thereof are therefore intended to be embraced by the claims.

What is claimed is:

1. A carriage driving apparatus having a first and a second guide members that extend, being adjacent to each other, and a carriage mounted movably to and between the, parallel queuing, first and second guide members, the carriage being movable reciprocally along a extending direction of the first guide member as being guided with the first and second guide members and having one side thereof in parallel to the extending direction and perpendicular to a queuing direction, comprising:
an extending member disposed at the first guide member, being formed in plate and extending in the queuing direction; and
a regulating part provided on the one side of the carriage to extend in the queuing direction such that, when the carriage receives a stress in one direction perpendicular to both the extending direction and the queuing direction, the regulating part comes into contact with the extending member to regulate displacement of the carriage along the one direction.

2. A carriage driving apparatus according to claim 1, wherein
the extending member extends throughout a dimension of the first guide member along the extending direction.

3. A carriage driving apparatus according to claim 1, wherein
the extending member is made separately of the first guide member as fixedly joined to the first guide member.

4. A carriage driving apparatus according to claim 2, wherein
the extending member is made separately of the first guide member as fixedly joined to the first guide member.

5. A carriage driving apparatus according to claim 3, wherein
the first guide member includes a rail portion provided thereon along the extending direction for guiding the carriage.

6. A carriage driving apparatus according to claim 4, wherein
the first guide member includes a rail portion provided thereon along the extending direction for guiding the carriage.

7. A carriage driving apparatus according to claim 5, wherein
the rail portion extends in the one direction perpendicular to both the extending direction and the queuing direction.

8. A carriage driving apparatus according to claim 6, wherein
the rail portion extends in the one direction perpendicular to both the extending direction and the queuing direction.

9. A carriage driving apparatus having a first and a second guide members that extend, being adjacent to each other, and a carriage mounted movably to and between the, parallel queuing, first and second guide members, the carriage being movable reciprocally along a extending direction of the first guide member as being guided with the first and second guide members and having one side thereof in parallel to the extending direction and perpendicular to a queuing direction, comprising:
an extending portion extending from the first guide member in the queuing direction; and
a regulating part provided on the one side of the carriage to extend in the queuing direction such that, when the carriage receives a stress in one direction perpendicular to both the extending direction and the queuing direction, the regulating part comes into contact with the extending portion of the first guide member to regulate displacement of the carriage along the one direction.

10. A carriage driving apparatus according to claim 9, wherein
the first guide member includes a rail member provided thereon along the extending direction for guiding the carriage.

11. A carriage driving apparatus according to claim 10, wherein
the rail member is made separately of the first guide member and fixedly joined to the first guide member.

12. An image forming apparatus for forming an image on a recording medium by ejecting an ink from an inkjet head, comprising the carriage driving apparatus according to claim 1, wherein
the inkjet head is mounted on the carriage, and
the carriage is driven along the extending direction as the inkjet head is ejecting the ink onto the recording medium.

13. An image forming apparatus according to claim 12, further comprising a maintenance mechanism for conducting a maintenance action for the inkjet head when coming into contact with the inkjet head mounted on the carriage, at a predetermined position, wherein
the extending member is arranged to come into contact with the regulating part at the predetermined location.

14. An image forming apparatus for forming an image on a recording medium by ejecting an ink from an inkjet head, comprising the carriage driving apparatus according to claim 9, wherein
the inkjet head is mounted on the carriage, and
the carriage is driven along the extending direction as the inkjet head is ejecting the ink onto the recording medium.

15. An image forming apparatus according to claim 14, further comprising a maintenance mechanism for conducting a maintenance action for the inkjet head when coming into contact with the inkjet head mounted on the carriage, at a predetermined position, wherein
the extending portion is arranged to come into contact with the regulating part at the predetermined location.
